(19) United States
(12) Patent Application Publication
(10) Pub. No.: US 2015/0169454 A1
(43) Pub. Date: Jun. 18, 2015

(54) PACKET TRANSFER SYSTEM AND METHOD FOR HIGH-PERFORMANCE NETWORK EQUIPMENT

(71) Applicant: WINS Co., Ltd., Gyeonggi-do (KR)

(72) Inventor: Yong Sig JIN, Gyeonggi-do (KR)

(21) Appl. No.: 14/547,157

(22) Filed: Nov. 19, 2014

(30) Foreign Application Priority Data
Nov. 19, 2013 (KR) 10-2013-0140916

(51) Int. Cl. G06F 12/08; G06F 12/02

(52) U.S. Cl. CPC G06F 12/0813; G06F 12/023; G06F 2212/1044; G06F 2212/154

(57) ABSTRACT

The present disclosure relates to a packet transfer system and method, which can greatly improve the efficiency of a packet transfer scheme using a memory pool technique. The packet transfer system for high-performance network equipment includes a memory pool processor configured to include therein one or more memory blocks and store packet information input to an NIC. A memory allocation manager is configured to control allocation and release of the memory blocks, update information of memory blocks in response to a request of a queue or an engine, and transfer memory block addresses. The queue is configured to request a memory block from the memory allocation manager, and transfer a received memory block address to outside of the queue. The engine is configured to receive the memory block address from the queue, and perform a predefined analysis task with reference to packet information.

### CROSS-REFERENCE TO RELATED APPLICATION

This application claims under 35 U.S.C. §119(a) the benefit of Korean Application No. 10-2013-0140916 filed Nov. 19, 2013, which is incorporated herein by reference.

### TECHNICAL FIELD

The present disclosure relates, in general, to packet transfer buffer technology required when network equipment operating in a transparent mode analyzes packets and, more particularly, to a packet transfer system and method, which can greatly improve the efficiency of a packet transfer scheme using a memory pool technique.

### BACKGROUND ART

Recently, the Internet has exerted a strong influence in the whole area ranging from the lifestyles of people to the business area of enterprises. In such an environment, it is common for persons to share the details of their lives via a web community, or for persons to enjoy the wireless Internet. As the use of the Internet has increased, the types of security threats and the scale of damage attributable to such threats have also increased. Recently, as threats from the early stage of the Internet such as simple hacking or viruses have developed into various current threats such as worms, spyware, Trojan horses, Distributed Denial of Service (DDoS) attacks, and application vulnerability attacks, the types, complexity, and destructive power of such malicious threats has increased. As solutions for such security threats, the development of integrated security systems has been actively conducted.

The operation modes of an integrated security system include a route mode and a transparent mode. The route mode is a mode in which network segments are separated and then the integrated security system acts as router equipment and in which routing protocols must be supported. The transparent mode is a mode in which network segments are not separated and the integrated security system acts as bridge equipment, and is advantageous in that network segments can be installed without modifying existing networks for operation of the transparent mode.

As a conventional scheme for transferring packets from a Network Interface Controller (NIC) to an analysis engine, a Buffer Switching Queue (BSQ) scheme is used in which, as shown in FIG. 5A, two queues, that is, an input queue 46 and an output queue 47, are provided between an NIC 10 and an analysis engine 50, and in which, if the input queue is filled with as many packets as the size thereof, the input queue 46 and the output queue 47 are switched with each other, as shown in FIG. 5B, thus allowing the analysis engine to use the packets contained in the output queue. In this scheme, after packets of the output queue 47 have been exhausted, the input queue 46 and the output queue 47 are switched again, as shown in FIG. 5B, and then the tasks of the input queue 46 and the output queue 47 are performed.

In such a conventional BSQ scheme, an input operation is performed at the input queue 46 and an output operation is performed at the output queue 47. Therefore, if the performance of the output queue 47 is deteriorated, buffer switching becomes late, as shown in FIG. 5C, and then the transfer of packets to the analysis engine 50 may be delayed.

Further, as shown in FIG. 6, when the conventional BSQ scheme is applied to a parallel engine structure, a task for calling a system function so as to transfer packets to be analyzed to the engines and for copying individual packets from the NIC to the queues of the engines is performed. However, this scheme is problematic in that the number of engines is increased and a lot of resources are occupied because fixed queues are required for respective engines and the speed of copying is slow, and in that repetitive processing loads occur on equipment requiring high performance.

Further, as shown in FIG. 7, when the conventional BSQ scheme is applied to a series engine structure, a procedure for copying the data of packets is performed to transfer packet information to a subsequent engine after analysis at a preceding engine has been terminated. Since copying is repeatedly performed in proportion to the depth of engines, a problem arises in that the entire performance is deteriorated depending on the complexity of the connected engine structure and processing time.

### SUMMARY

Accordingly, the present disclosure has been made keeping in mind the above problems occurring in the prior art, and the present disclosure provide a packet transfer system for high-performance network equipment, which applies a memory pool to the packet transfer system, thus solving the problem of an increase in computation time and memory space due to a packet copy procedure.

The present disclosure may shorten the time required to copy data by allowing a plurality of queues to simultaneously refer to a single memory pool in a parallel engine structure.

The present disclosure may utilize a scheme for assigning the right to access a memory block to a subsequent memory allocation manager in a series engine structure and swapping an internal memory block with a received memory block.
The present disclosure may provide a packet transfer method for high-performance network equipment, which stores packets transferred to an NIC in a memory pool, thus referring to packet information based on memory block addresses.
In accordance with an aspect of the present disclosure, there is provided a packet transfer system for high-performance network equipment, including a memory pool processor configured to include therein one or more memory blocks and store packet information input to a Network Interface Controller (NIC), a memory allocation manager configured to control allocation and release of the memory blocks, update information of memory blocks in response to a request of a queue or an engine, and transfer memory block addresses, the queue configured to request a memory block from the memory allocation manager, and transfer a received memory block address to outside of the queue, and the engine configured to receive the memory block address from the queue, and perform a predefined analysis task with reference to packet information. The engine may include a plurality engines, and may be configured to, when the engines have a parallel structure, share memory block addresses of the memory pool, and refer to the memory block addresses.

The engine may include a plurality of engines, and may be configured such that, when the engines have a series structure, a subsequent engine includes an additional memory pool, and such that, if a memory block address is transferred from a preceding engine, the transferred memory block address is swapped with a specific internal memory block address of the subsequent engine.

The memory allocation manager may be configured to check whether another engine referring to the memory block address transferred from the preceding engine is present, upon swapping the memory block addresses with each other, and if another engine referring to the memory block address is not present, assign a right to access the memory block to a subsequent memory pool.

In accordance with another aspect of the present disclosure, there is provided a packet transfer method for high-performance network equipment, including (a) reading a packet input to a Network Interface Controller (NIC) and storing the packet in an internal memory block of a memory pool, (b) if a request for a memory block address (MBP) of a queue is input to a memory allocation manager, inquiring the memory pool, and transferring the memory block address to the queue, (c) if a request for a memory block address of an engine is input to the queue, inquiring the queue about the memory block address, and transferring the inquired memory block address to the engine, and (d) performing a predefined packet analysis task with reference to packet information corresponding to the memory block address, transferred at (c), by using the engine.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a configuration diagram showing the overall configuration of a packet transfer system for high-performance network equipment according to the present disclosure;

FIG. 2 is a conceptual diagram showing a parallel engine structure to which the packet transfer system for high-performance network equipment according to the present disclosure;

FIG. 3 is a conceptual diagram showing a series engine structure to which the packet transfer system for high-performance network equipment according to the present disclosure;

FIG. 4 is a flowchart showing the detailed flow of a packet transfer method for high-performance network equipment according to the present disclosure;

FIGS. 5A to 5C are conceptual diagrams showing a packet transfer method for a conventional BSQ scheme;

FIG. 6 is a conceptual diagram showing a parallel engine structure in the conventional BSQ scheme; and

FIG. 7 is a conceptual diagram showing a series engine structure in the conventional BSQ scheme.

### DETAILED DESCRIPTION

Hereinafter, embodiments of the present disclosure will be described in detail with reference to the accompanying drawings. Reference now should be made to the elements of drawings, in which the same reference numerals are used throughout the different drawings to designate the same elements. In the following description, detailed descriptions of known elements or functions that may unnecessarily make the gist of the present disclosure obscure will be omitted.

Detailed configurations and operations of a packet transfer system and method for high-performance network equipment according to the present disclosure will be described in detail with reference to the attached drawings.

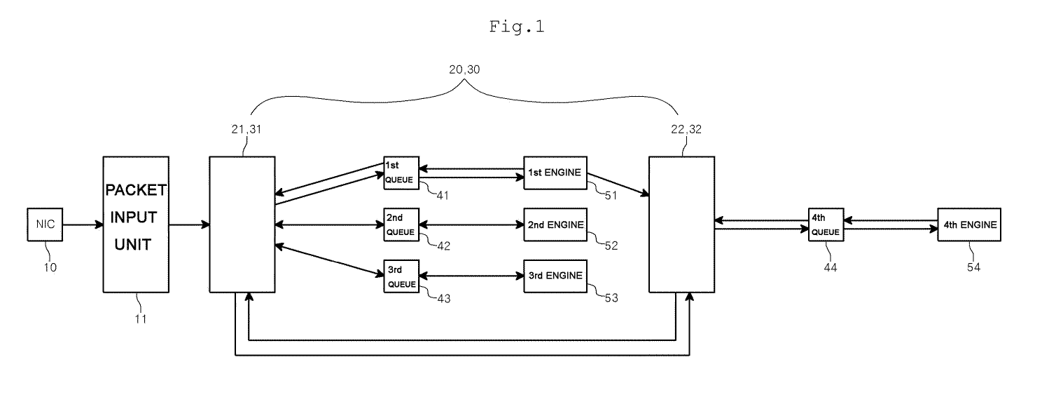

FIG. 1 is a diagram showing the overall configuration of a packet transfer system for high-performance network equipment according to the present disclosure, wherein the packet transfer system includes a memory pool 20, a memory allocation manager 30, queues 41 to 44, and engines 51 to 54.

The memory pool 20 includes therein one or more memory blocks, and stores packet information input to a Network Interface Controller (NIC) 10. The memory allocation manager 30 controls the allocation and release of the memory blocks, updates the information of memory blocks in response to the request of queues or engines, and transfers memory block addresses (memory block pointers: MBPs).

The queues 41 to 44 request the memory blocks from the memory allocation manager 30, and transfer received memory block addresses to the engines 51 to 54. The engines 51 to 54 receive the memory block addresses from the queues 41 to 44 and perform predefined analysis tasks with reference to packet information.

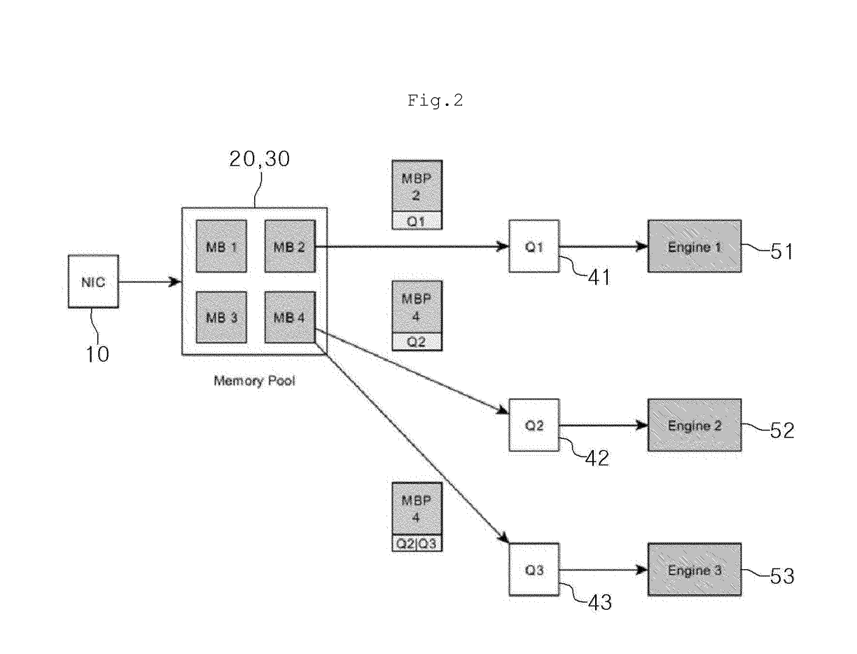

FIG. 2 is a conceptual diagram showing a parallel engine structure to which the packet transfer system for high-performance network equipment according to the present disclosure. In the parallel engine structure, packet information is stored in fixed-size buffers called memory blocks within the memory pool 20, instead of copying packets, and memory block addresses are transferred to the queues 41 to 43, and then the packet information is referred to and used.

Since there is no packet input buffer required for each engine, the size of an allocated memory space is reduced to about 1/n of an existing space. Further, since several queues 41 to 43 can simultaneously refer to the memory blocks, the time required to copy data can be shortened.

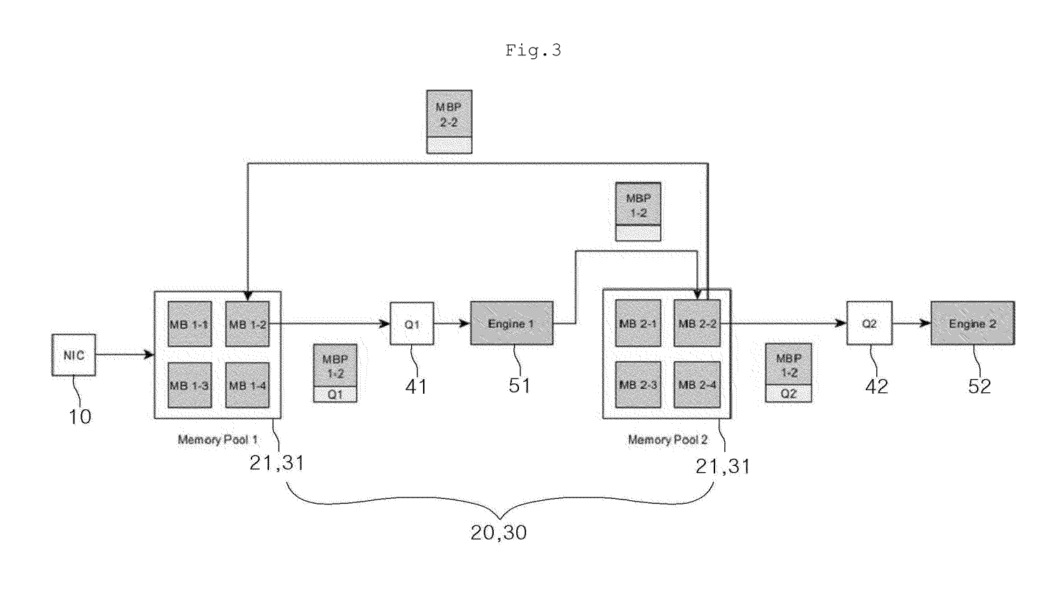

FIG. 3 is a conceptual diagram showing a series engine structure to which the packet transfer system for high-performance network equipment according to the present disclosure. In the series engine structure, a first engine 51 analyzes packet using a first memory pool 21, and then transfers a memory block address (MBP) to a subsequent second engine 52. The subsequent second engine 52 has a separate second memory pool 22, and is configured to, when the memory block address is transferred from a preceding engine, check whether another queue is referring to the corresponding memory block, and then obtain the right to access the memory block. After obtaining the right to access, the second engine 52 swaps an internal memory block with the transferred memory block, thus reducing the load of a packet transfer procedure and improving the analysis performance of the equipment.

As described above, when the packet transfer system for high-performance network equipment according to the present disclosure is applied, packets are transferred using the memory pools, thus realizing the advantages of not only solving the problems of an increase in computation time and memory space caused by a packet copy procedure, but also greatly improving the efficiency of data transfer.

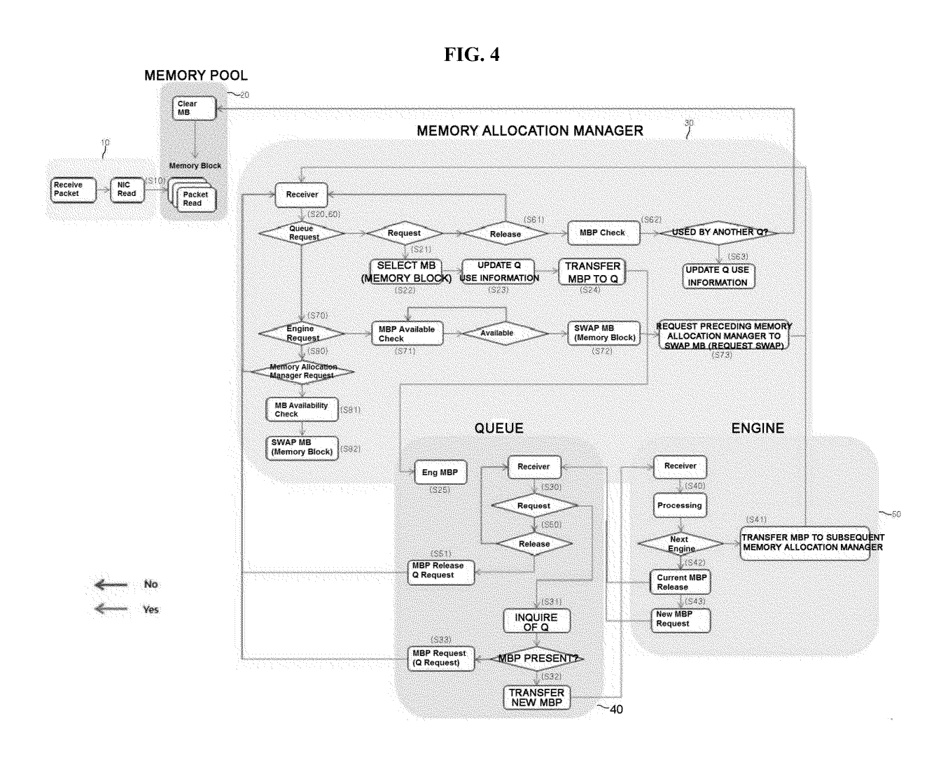

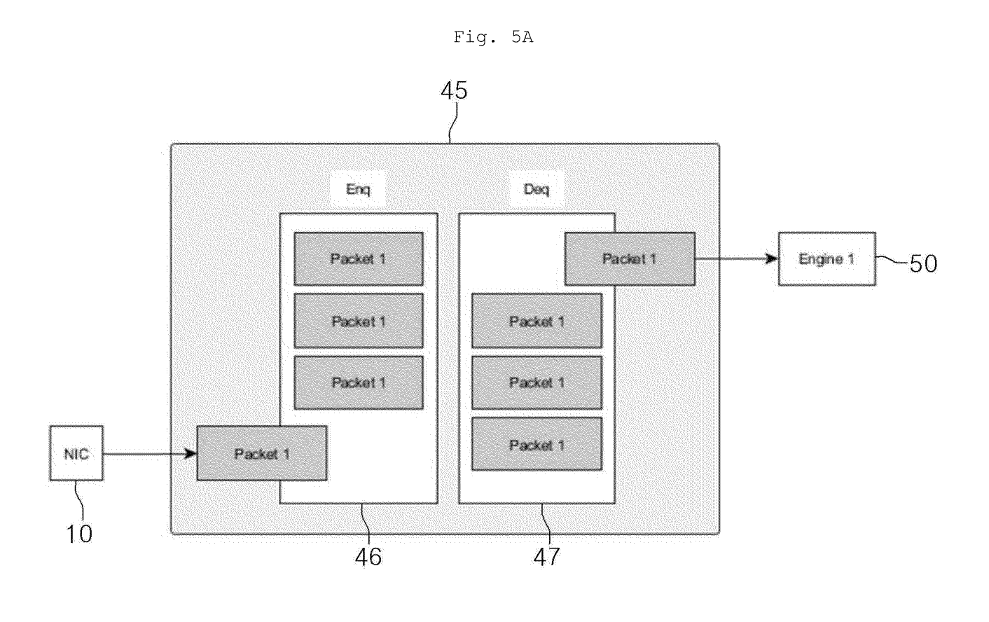

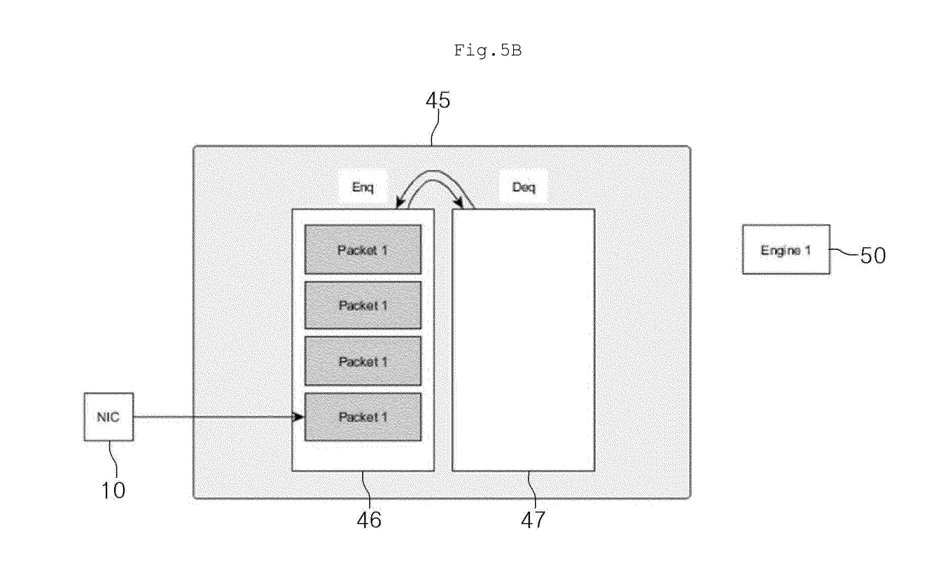

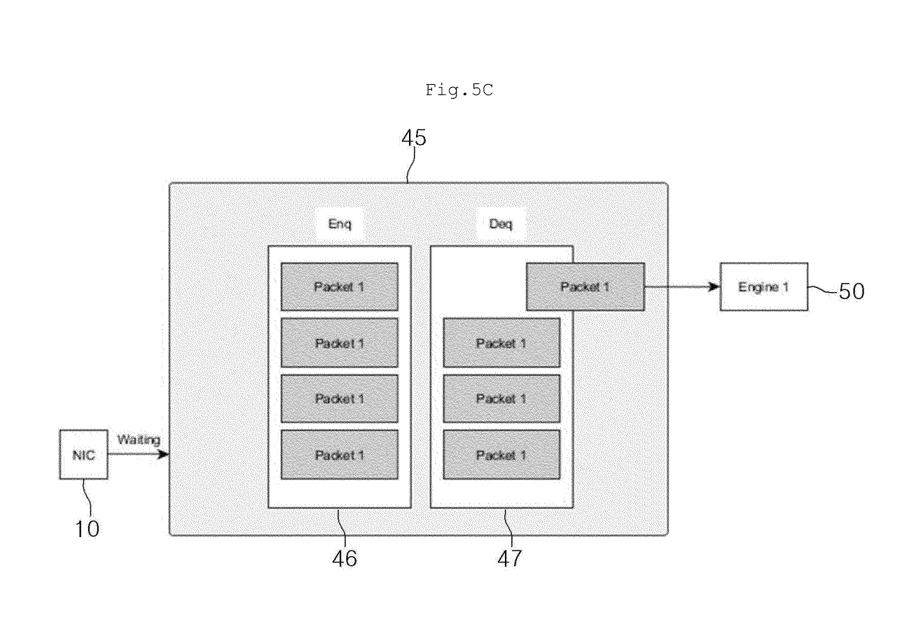

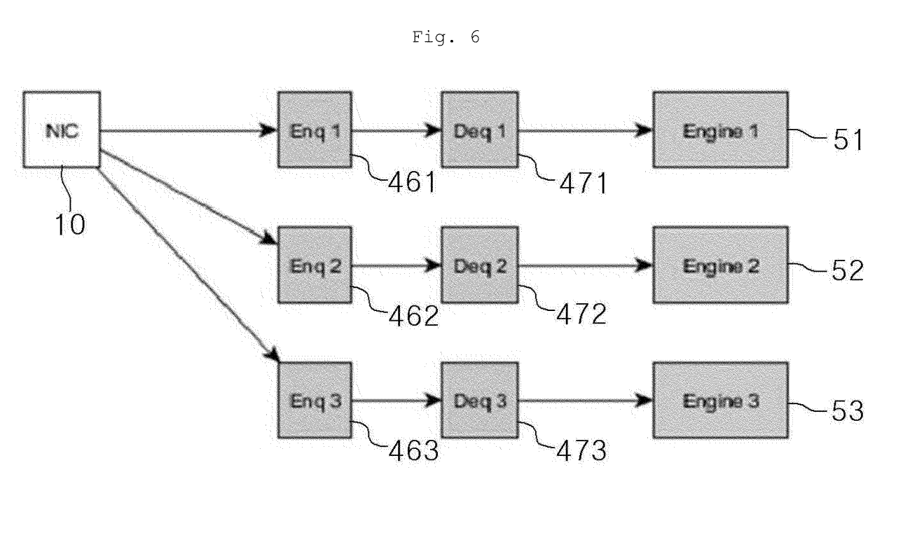

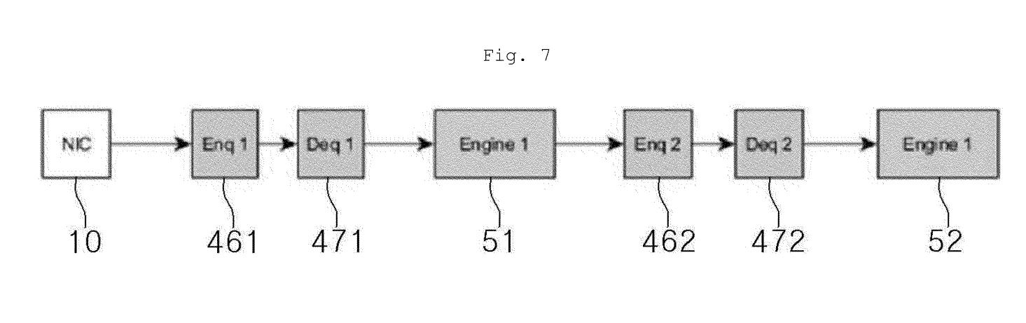

FIG. 4 is a flowchart showing the detailed flow of a packet transfer method performed by the packet transfer system for high-performance network equipment according to the present disclosure. Below, the packet transfer method will be described in detail.

First, a packet input to the NIC 10 is read and stored in the internal memory block of the memory pool at step S10. At this time, the memory allocation manager 30 allocates an address to the memory block.

Next, when a request for the memory block address (MBP) of the queue 40 is input to the memory allocation manager 30, the packet transfer system inquires of the memory pool 20 about the memory block address, and transfers the memory block address to the queue at step S20.

Step S20 is described in detail below. It is determined whether the input request is a request for the memory block address (MBP) of the queue 40 at step S21. The memory pool 20 is inquired of, and then a memory block to respond to the request is selected at step S22. The information of the queue 40 which will use the selected memory block is updated to the memory block information at step S23. Then, the memory block address is transferred to the queue 40 at step S24.

Further, the queue 40 that received the memory block address at step S24 sequentially stores the memory block address at step S30.

Meanwhile, if a request for the memory block address of the engine 50 is input to the queue 40, the packet transfer system inquires of the internal space of the queue about the memory block address, and transfers the inquired memory block address to the engine at step S30.

Step S30 is described in detail below. When the engine requests a memory block address from the queue 40, the queue 40 is inquired of at step S31, and it is determined whether the memory block address is present in the queue 40. If it is determined that the memory block address is present in the queue, the memory block address is transferred to the engine 50 at step S32, whereas if it is determined that the memory block address is not present in the queue, the memory block address is requested from the memory allocation manager at step S33.

Further, a predefined packet analysis task is performed with reference to the packet information corresponding to the memory block address transferred at step S33 by using the engine 50 at step S40.

After step S40, the use of the memory block address is terminated, and it is determined whether a subsequent engine is present. If the subsequent engine is present, the memory block address is transferred to the memory allocation manager of the subsequent engine at step S41. In contrast, if a subsequent engine is not present, a release command for the used memory block address is transmitted to the queue 40 at step S42, and a new memory block address is requested from the queue 40 at step S43.

After step S42, the queue 40 determines whether the current command is a release command for the memory block address at step S50. If it is determined that the command is the release command for the memory block address, the queue transfers the release command for the used memory block address to the memory allocation manager 30 at step S51.

After step S51, the memory allocation manager 30 checks whether the command transferred from the queue is a release command for the memory block address at step S61, and checks whether the memory block address for which the release command has been transferred is being used by another queue at step S62. If the memory block address is being used by another queue, the memory block information is updated at step S63, whereas if the memory block address is not being used by another queue, the memory block is initialized at step S64.

Further, when the engine 50 transfers the memory block address to the subsequent memory allocation manager 30 at step S70, memory block information is inspected and it is checked whether the memory block address is being used by another queue 40 at step S71. If the memory block address is not being used by another queue, the memory block address of the current memory allocation manager is swapped with the memory block address transferred from the preceding engine at step S72. A swap command and the memory block address of the current memory allocation manager are transferred to a preceding memory allocation manager at step S73.

Further, if the preceding memory allocation manager receives the swap command for the memory block address from the subsequent memory allocation manager at step S80, it inspects memory block information and checks whether the memory block address is being used by another queue at step S81. If the memory block address is not used by another queue, the memory block address of the subsequent memory allocation manager is swapped with the memory block address of the current memory allocation manager at step S82.

As described above, the present disclosure is advantageous in that, when the packet transfer method for high-performance network equipment according to the present disclosure is used, there is provided a method that can store packets transferred to the NIC in the memory pool, refer to packet information using memory block addresses, and swap memory block addresses in the case of a multi-step engine structure, thus decreasing the complexity of engine structures and improving the entire packet transmission efficiency.

As described above, the packet transfer system for high-performance network equipment according to the present disclosure is advantageous in that it applies a memory pool to the packet transfer system, thus not only solving the problem of an increase in computation time and memory space caused by a packet copy procedure, but also greatly improving the efficiency of data transfer.

Further, there is an advantage in that, in a parallel engine structure, a plurality of queues simultaneously refer to a single memory pool, so that the time required to copy data can be shortened, and in that there is no need to provide separate packet input buffers for respective engines, so that the size of an allocated memory space can be reduced to about 1/n of an existing space.

Furthermore, the present disclosure is advantageous in that, in a series engine structure, the right to access a memory block is assigned to a subsequent memory allocation manager, so that a scheme for swapping an internal memory block with a received memory block is used, thus reducing the load of a packet transfer procedure and improving the analysis performance of equipment.

Furthermore, the packet transfer method for high-performance network equipment according to the present disclosure is advantageous in that it can provide a method of storing packets transferred to an NIC in a memory pool and of referring to packet information using memory block addresses, thus decreasing the complexity of engine structures and improving the entire packet transfer performance.

Although the embodiments of the present disclosure have been disclosed, those skilled in the art will appreciate that the present disclosure is not limited by those embodiments, and the present disclosure may be implemented as various packet transfer systems and methods for high-performance network equipment without departing from the scope and spirit of the disclosure.

What is claimed is:

1. A packet transfer system for high-performance network equipment, comprising:
a memory pool processor configured to include therein one or more memory blocks and store packet information input to a Network Interface Controller (NIC);
a memory allocation manager configured to control allocation and release of the memory blocks, update information of memory blocks in response to a request of a queue or an engine, and transfer memory block addresses;
the queue configured to request a memory block from the memory allocation manager, and transfer a received memory block address to outside of the queue; and
the engine configured to receive the memory block address from the queue, and perform a predefined analysis task with reference to packet information.

2. The packet transfer system of claim 1, wherein the engine includes a plurality engines, and is configured to, when the engines have a parallel structure, share memory block addresses of the memory pool, and refer to the memory block addresses.

3. The packet transfer system of claim 1, wherein the engine includes a plurality of engines, and is configured such that, when the engines have a series structure, a subsequent engine includes an additional memory pool, and such that, if a memory block address is transferred from a preceding engine, the transferred memory block address is swapped with a specific internal memory block address of the subsequent engine.

4. The packet transfer system of claim 3, wherein the memory allocation manager is configured to:
check whether another engine referring to the memory block address transferred from the preceding engine is present, upon swapping the memory block addresses with each other, and
if another engine referring to the memory block address is not present, assign a right to access the memory block to a subsequent memory pool.

5. A packet transfer method for high-performance network equipment, comprising:
(a) reading a packet input to a Network Interface Controller (NIC) and storing the packet in an internal memory block of a memory pool;
(b) if a request for a memory block address (MBP) of a queue is input to a memory allocation manager, inquiring of the memory pool, and transferring the memory block address to the queue;
(c) if a request for a memory block address of an engine is input to the queue, inquiring of an internal space of the queue about the memory block address, and transferring the inquired memory block address to the engine; and
(d) performing a predefined packet analysis task with reference to packet information corresponding to the memory block address, transferred at (c), by using the engine.

6. The packet transfer method of claim 5, wherein (b) comprises:
(b-1) inquiring of the memory pool and selecting a memory block to respond to the request;
(b-2) updating information of the queue that will use the selected memory block to memory block information;
(b-3) transferring the memory block address to the queue; and
(b-4) sequentially storing the transferred memory block address.

7. The packet transfer method of claim 5, wherein (c) comprises:
(c-1) if the memory block address is not present, upon inquiring of the internal space of the queue, returning to (b) and re-performing (b).

8. The packet transfer method of claim 5, further comprising, after (d):
(d-1) after use of the memory block address is terminated, determining whether a subsequent engine is present, and if it is determined that the subsequent engine is present, transferring the memory block address to a memory allocation manager of the subsequent engine;
(d-2) if it is determined at (d-1) that a subsequent engine is not present, transmitting a release command for the used memory block address to the queue; and
(d-3) requesting a new memory block address from the queue.

9. The packet transfer method of claim 8, further comprising, after (d-2):
(d-4) transferring a release command for the used memory block address to the memory allocation manager using the queue.

10. The packet transfer method of claim 9, further comprising, after (d-3):
(e-1) checking, by the memory allocation manager, whether the memory block address for which the release command has been transferred to the queue is being used by another queue;
(e-2) if it is checked at (e-1) that the memory block address is being used by another queue, updating the memory block information; and
(e-3) if it is checked at (e-1) that the memory block address is not being used by another queue, initializing the memory block.

11. The packet transfer method of claim 8, further comprising, after (d-1):
(f-1) inspecting memory block information, and checking whether the memory block address is being used by another queue;
(f-2) if the memory block address is not being used by another queue at (f-1), swapping a memory block address of a current memory allocation manager with the memory block address transferred from a preceding engine; and
(f-3) transferring a swap command and the memory block address of the current memory allocation manager to a preceding memory allocation manager.

12. The packet transfer method of claim 11, further comprising, after (f-3):
(g-1) checking whether the memory block address for which the swap command has been transferred is being used by another queue; and
(g-2) if the memory block address is not used by another queue, swapping a memory block address of a subsequent memory allocation manager with the memory block address of the current memory allocation manager.
